(19) United States
(12) Patent Application Publication
(10) Pub. No.: US 2019/0108050 A1
(43) Pub. Date: Apr. 11, 2019

(54) OPERATION DEVICE, COMMUNICATION SYSTEM, AND UPDATE METHOD

(71) Applicant: NEC Corporation, Minato-ku, Tokyo (JP)

(72) Inventor: Shinya ISHIDA, Tokyo (JP)

(73) Assignee: NEC Corporation, Minato-ku, Tokyo (JP)

(21) Appl. No.: 16/086,661

(22) PCT Filed: Mar. 21, 2017
(86) PCT No.: PCT/JP2017/011097

§ 371 Date: Sep. 20, 2018

(30) Foreign Application Priority Data
Mar. 30, 2016 (JP) 2016-066980

(51) Int. Cl. G06F 9/455; G06F 9/50

(52) U.S. Cl. CPC G06F 9/45558; G06F 2009/4557; G06F 9/5077

(57) ABSTRACT

The present invention provides an operation device that can satisfy required conditions of a delay and a bandwidth while suppressing surplus resources, when updating a virtual machine. The operation device in one aspect of the present invention includes: update procedure calculating unit that determines an update procedure for sequentially updating a virtual machine; and update executing unit that executes an update of a plurality of the virtual machines in accordance with the determined update procedure, wherein the update procedure calculating unit includes: extracting candidates for calculation resources of an update destination with respect to each of the virtual machines, and determining the calculation resources of the update destination of each of the virtual machines and an order of updating the virtual machines, based on the extracted candidates for the calculation resources of the update destination.

### TECHNICAL FIELD

The present invention relates to an operation device, a communication system, and an update method.

### BACKGROUND ART

With the development of cloud technology, it has become general to execute an application program on a virtual machine. By using virtual machines, a user, who uses an application program, can activate only necessary machines when necessary, and can minimize surplus resources. In addition, the virtual machine provides the user with advantages that the user is neither required to actually possess equipment, nor to be aware of a physical place where the virtual machine is disposed.

NPL 1 discloses a technique of connecting geographically distributed data centers to a dedicated line disposed in a wide area network. In the technique disclosed in NPL 1, the data centers are connected to the dedicated line and are used as one cloud. Thereby, more flexible, and a wider range of, services can be provided to mobile users.

On the other hand, even when using the virtual machines, internal software needs to be maintained, like physical machines, in order to solve bugs and security problems. NPL 2 discloses Blue-Green Deployment as an update method of a server on a virtual machine. In the Blue-Green Deployment, in addition to a virtual machine (Green slice) which executes a network application of a Web, etc., there is provided another virtual machine (Blue slice) in which a desired update was executed. The Blue slice synchronizes the data of the Blue slice with the data of the Green slice. After the establishment of the synchronization, in a router transferring traffic to the Green slice, the transfer destination of the traffic is switched from the Green slice to Blue slice. Thereby, software update can be executed without logically halting services. In addition, after the transfer destination of the traffic is switched from the Green slice to Blue slice, the resources used by the Green slice can be switched to use for the next update.

### CITATION LIST

### Non Patent Literature

[NPL 1] Tarik Taleb, “Toward Carrier Cloud Potential, Challenges, and Solutions, “IEEE Wireless Communications, vol. 21, no. 3, June 2014, pp. 80-91.

[NPL 2] Ken Collier “Agile Analytics “Addison-Wesley, July 2011, pp. 169-170

### SUMMARY OF INVENTION

### Technical Problem

As described above, NPL 1 discloses a means for determining an optimal disposition location at a time of providing a new virtual machine. In the technique described in NPL 1, when a delay and a bandwidth between a new virtual machine and an existing virtual machine, with which the new virtual machine can communicate, are referred to as a network distance, the new virtual machine is provided at a location where the sum of the network distances between the new virtual machine and existing virtual machines becomes minimum.

However, even if the network distance is minimum, there is concern that a desired performance is not satisfied with respect to the delay, the amount of bandwidth, etc.

Besides, in order to apply the Blue-Green Deployment disclosed in NPL 2, double the amount of calculation resources is required since two virtual machines are activated for one server. When update work is necessary for many virtual machines, the same number of calculation resources as the virtual machines need to be disposed as surplus resources, resulting in large cost. In particular, when a plurality of distributed data centers are configured as one cloud environment, it is not realistic to think that there are a plenty of surplus calculation resources, from the standpoint of the sizes of buildings, the supply capability of electric power, material cost, etc.

Furthermore, also in the cloud environment, design is needed for enabling application programs to achieve desired performances. Even if software can be updated while the connectivity of the server is maintained by the Blue-Green Deployment, it is possible that the required condition of a delay and a bandwidth cannot be satisfied, depending on the location of the Blue slice.

The object of the invention is to provide, in consideration of the above problem, an operation device, etc. capable of satisfying required conditions of a delay and a bandwidth while suppressing surplus resources, when updating a virtual machine.

### Solution to Problem

An operation device according to an aspect of the present invention includes:

update procedure calculating unit that determines an update procedure for sequentially updating a virtual machine; and

update executing unit that executes an update of a plurality of the virtual machines in accordance with the determined update procedure,

wherein the update procedure calculating unit includes:

extracting candidates for calculation resources of an update destination with respect to each of the virtual machines, and

determining the calculation resources of the update destination of each of the virtual machines and an order of updating the virtual machines, based on the extracted candidates for the calculation resources of the update destination.

A communication system according to an aspect of the present invention includes:

calculation resources in which a virtual machine is constituted; and

an operation device that instructs an update of the virtual machine.

The operation device includes:

update procedure calculating unit that determines an update procedure for sequentially updating a plurality of the virtual machines; and

update executing unit that executes an update of the virtual machines in accordance with the determined update procedure,

wherein the update procedure calculating unit is configured:

to extract candidates for calculation resources of an update destination with respect to each of the virtual machines, and

to determine the calculation resources of the update destination of each of the virtual machines and an order of updating the virtual machines, based on the extracted candidates for the calculation resources of the update destination.

An update method for sequentially updating a virtual machine, according to an aspect of the present invention includes:

extracting candidates for calculation resources of an update destination with respect to each of a plurality of the virtual machines;

determining the calculation resources of the update destination of each of the virtual machines and an order of updating the virtual machines, based on the extracted candidates for the calculation resources of the update destination; and

executing an update of the virtual machines in accordance with the determined order of updating.

### Advantageous Effects of Invention

An operation device in one aspect of the present invention can satisfy required conditions of a delay and a bandwidth while suppressing surplus resources, when updating a virtual machine.

### BRIEF DESCRIPTION OF DRAWINGS

FIG. 1 illustrates a communication network configuration example of a first example embodiment of the present invention;

FIG. 2 illustrates a configuration example of operation device 60 of the first example embodiment of the present invention;

FIG. 3 illustrates a configuration example of network topology management table 611 which is stored in topology information storage unit 61 of the first example embodiment of the present invention;

FIG. 4 illustrates a configuration example of table 621 of nodes on communication path candidates, which is stored in path candidate storage unit 62 of the first example embodiment of the present invention;

FIG. 5 illustrates a configuration example of table 622 of links on communication path candidates, which is stored in path candidate storage unit 62 of the first example embodiment of the present invention;

FIG. 6 illustrates a configuration example of information of a flow, which is stored in flow information storage unit 63 of the first example embodiment of the present invention;

FIG. 7 illustrates a different communication network configuration example of the first example embodiment of the present invention;

FIG. 8 is a flowchart illustrating an operation example of update procedure calculating unit 64 of the first example embodiment of the present invention;

FIG. 9 is a view illustrating move destination candidates of virtual machines 40 of the first example embodiment of the present invention;

FIG. 10 is a view illustrating an update procedure of virtual machines 40 of the first example embodiment of the present invention;

FIG. 11 is a flowchart illustrating an operation example of update executing unit 65 of the first example embodiment of the present invention;

FIG. 12 illustrates a configuration example of operation device 60 of a second example embodiment of the present invention;

FIG. 13 illustrates a configuration example of different operation device 60 of the second example embodiment of the present invention;

FIG. 14 is a flowchart illustrating an operation example of update procedure calculating unit 64 of the second example embodiment of the present invention;

FIG. 15 illustrates a configuration example of operation device 60 of a third example embodiment of the present invention; and

FIG. 16 is a flowchart illustrating an operation example of operation device 60 of the third example embodiment of the present invention.

### EXAMPLE EMBODIMENT

Hereinafter, example embodiments of the present invention will be described with reference to the drawing. Each example embodiment is illustrated by way of example, and the present invention is not limited to each example embodiment. Note that reference signs in the drawings, which are supplementarily noted in the description of the outline of each example embodiment, are supplementarily added to the respective elements by way of example, for the purpose of convenience, in order to help understanding, and the description of the outline is not intended to add any limitations.

### First Example Embodiment

[Description of Configuration]

A first example embodiment of the present invention will be described in detail with reference to the drawings.

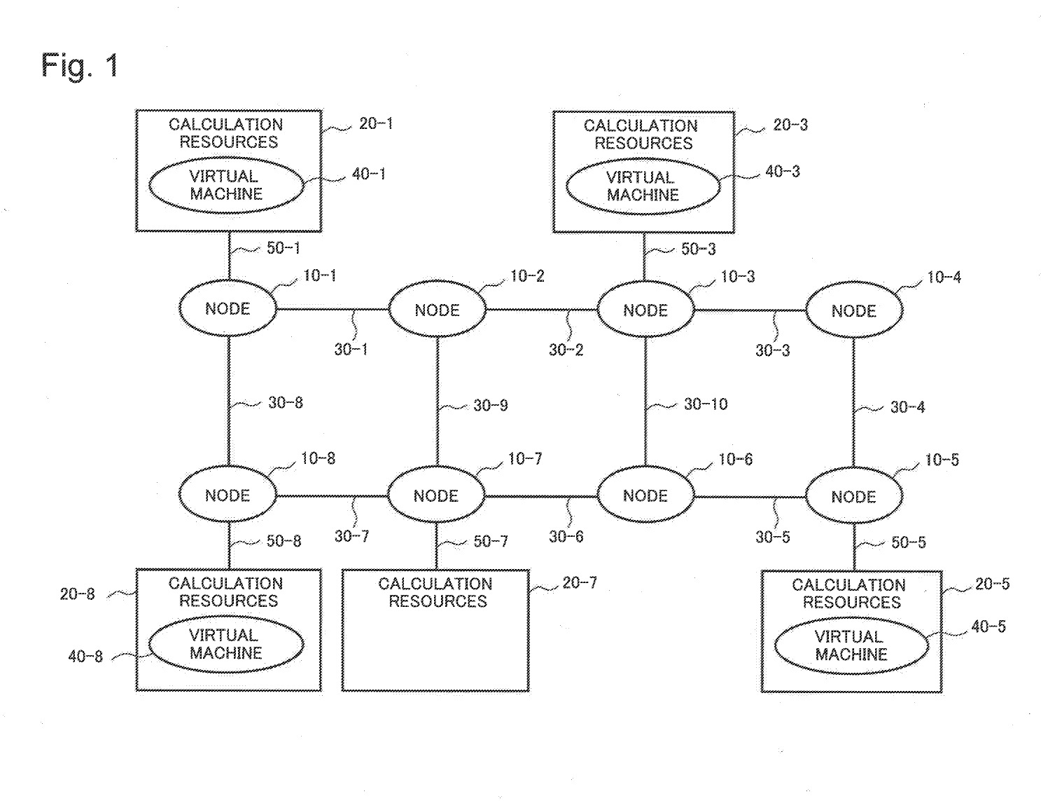

FIG. 1 illustrates a communication network configuration example of the first example embodiment of the present invention.

A communication network in the first example embodiment of the present invention includes nodes 10, calculation resources 20, inter-node links 30, virtual machines 40, and calculation resources links 50. For example, nodes 10 are node 10-1 to node 10-8. A hyphen “-” and a sign (1, 2, . . . ) following the hyphen are omitted in some cases for the purpose of convenience of description.

Note that solid lines connecting structural elements 10 to 50 in FIG. 1 indicate logical communication or a callable relationship, and an implementation mode of structural elements 10 to 50 is not limited to the configuration or network in which structural elements 10 to 50 are connected in the illustrated shape. In addition, the communication network is not limited to the configuration example of FIG. 1. For example, the communication network may include a greater number of nodes 10 or inter-node links 30, and the connection may be a different one.

Node 10 is, for instance, a physical switch or router, or a virtual switch or router. Each node 10 executes, for example, relays data or controls transferring data. Nodes 10 are connected via inter-node link 30. Inter-node link 30 may be a physical link or a virtual link.

Calculation resources 20 are connected to node 10 (network) via calculation resources link 50. Calculation resources link 50 may be a physical link or a virtual link. Calculation resources 20 are composed of, for example, a central processing unit (CPU), a random access memory (RAM) and a hard disk.

Virtual machine 40 is disposed by using calculation resources 20. Virtual machines 40 communicate with virtual machines 40 via calculation resources links 50 and inter-node links 30.

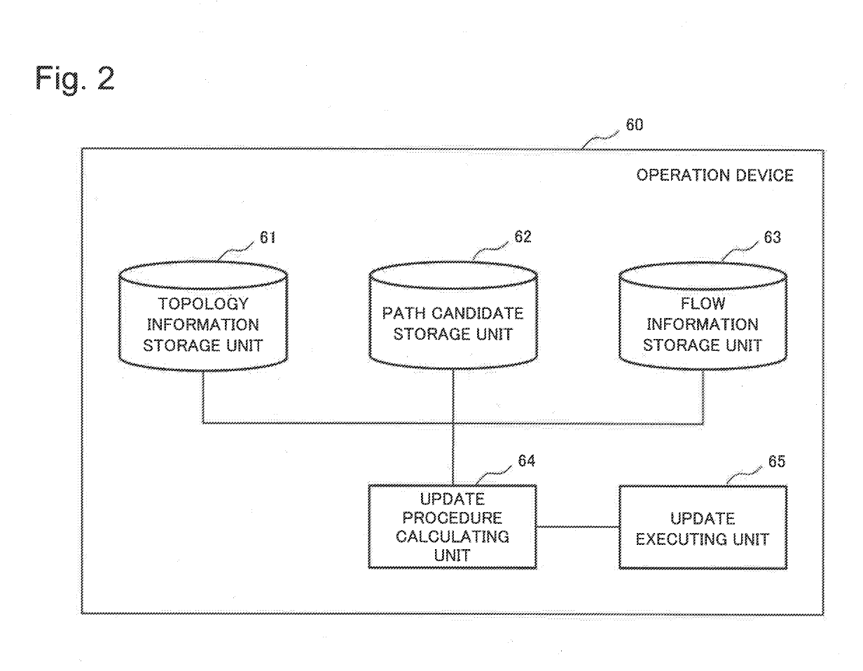

FIG. 2 illustrates a configuration example of operation device 60 in the first example embodiment of the present invention.

Operation device 60 in the first example embodiment of the present invention manages the communication network in the first example embodiment of the present invention. Operation device 60 includes topology information storage unit 61, path candidate storage unit 62, flow information storage unit 63, update procedure calculating unit 64 and update executing unit 65.

Note that solid lines connecting structural elements 61 to 65 in FIG. 2 indicate logical communication or a callable relationship, and an implementation of structural elements 61 to 65 is not limited to the configuration or network in which structural elements 61 to 65 are connected in the illustrated shape.

In the description below, for the purpose of simplicity, it is assumed that a delay time of each inter-node link 30 and each calculation resources link 50 is 1. However, delay times of the links in the network, to which the present invention is applied, may be different. In the description below, for the purpose of simplicity, it is assumed that a delay in the node is 0. However, for example, if a delay in the node is measured or if a communication delay time between virtual machines is measured, the delay time in the node can be taken into account.

In the description below, for the purpose of simplicity, a case is described by way of example, in which software in virtual machines 40-1, 40-3 and 40-5 is to be updated in the communication network of FIG. 1.

Topology information storage unit 61 stores information relating to a connection relation (topology) between nodes 10, calculation resources 20, inter-node links 30 and calculation resources links 50.

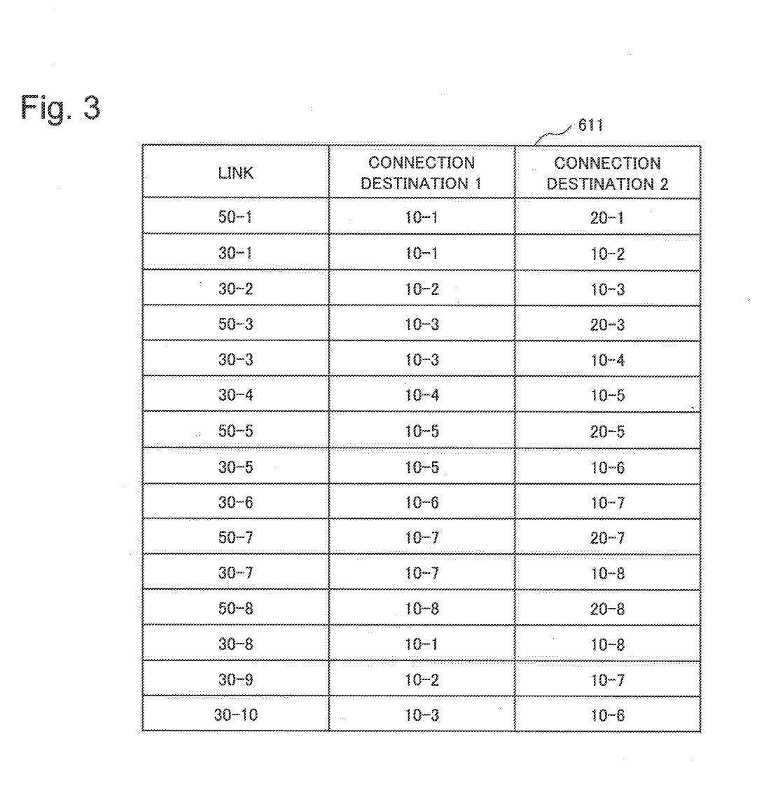

FIG. 3 illustrates a configuration example of network topology management table 611 which is stored in topology information storage unit 61 of the first example embodiment of the present invention. For example, if network topology management table 611 is referred to, node 10-1 and calculation resources 20-1 are connected to calculation resources link 50-1. The information stored in topology information storage unit 61 is not limited to a link ID (IDentifier) and IDs of nodes 10 which the communication link connects. For example, topology information storage unit 61 may store, for example, the name of a link, internet protocol (IP) address, media access control (MAC) address, transmission control protocol (TCP) address, serial number, and uniform resource locator (URL) which refers to an IP address.

Path candidate storage unit 62 stores candidate information of communication paths between calculation resources 20, the communication paths existing on the topology of the communication network stored in topology information storage unit 61. Path candidate storage unit 62 stores one or more candidates of communication paths between calculation resources 20 in which virtual machines 40 can be disposed, in the topology stored in topology information storage unit 61.

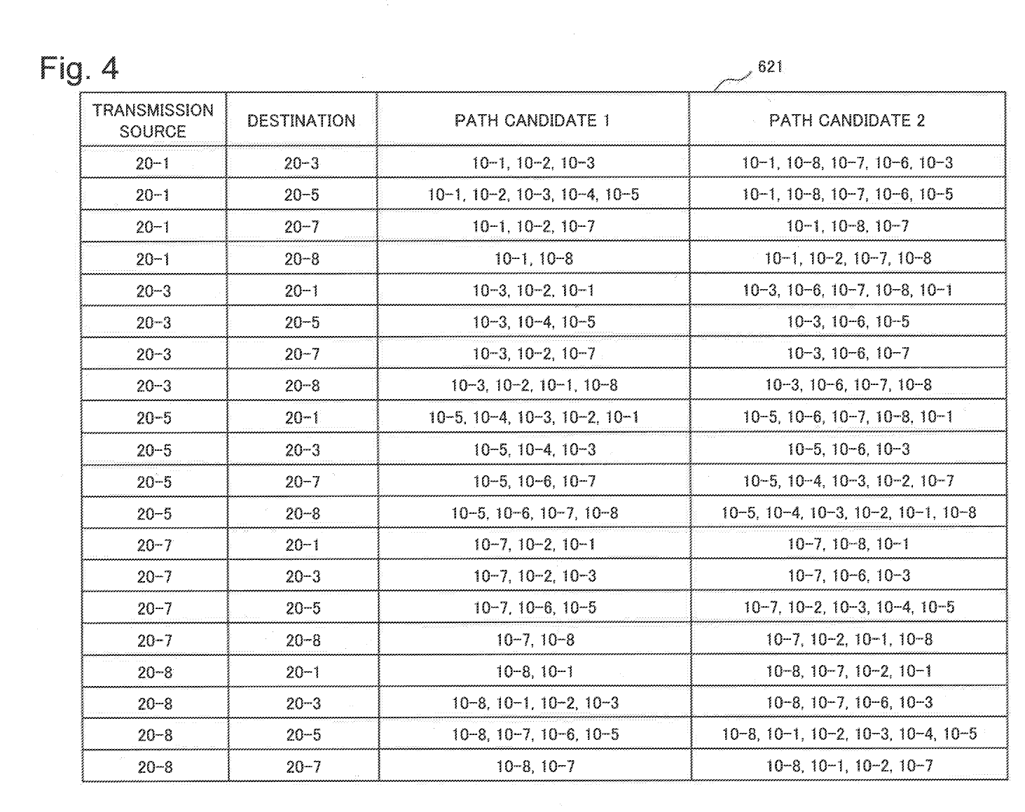

FIG. 4 illustrates a configuration example of table 621 of nodes on communication path candidates, which is stored in path candidate storage unit 62 in the first example embodiment of the present invention. For example, in the table 621 of nodes on communication path candidates, there are two path candidates when data are transferred from calculation resources 20-3 to calculation resources 20-5. Path candidate 1 for transferring data from calculation resources 20-3 to calculation resources 20-5 passes through node 10-3, node 10-4 and node 10-5. Path candidate 2 for transferring data from calculation resources 20-3 to calculation resources 20-5 passes through node 10-3, node 10-6 and node 10-5.

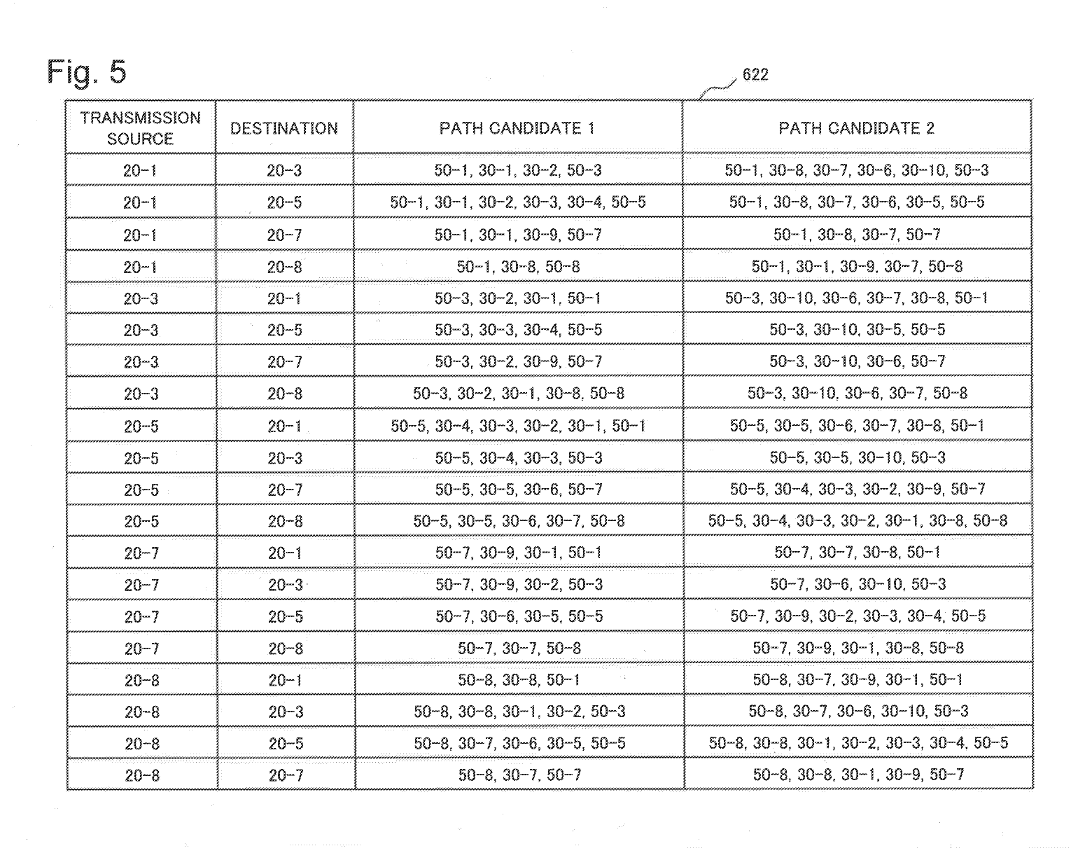

FIG. 5 illustrates a configuration example of table 622 of links on communication path candidates, which is stored in path candidate storage unit 62 in the first example embodiment of the present invention. For example, in the table 622 of links on communication path candidates, there are two path candidates when data are transferred from calculation resources 20-1 to calculation resources 20-3. Path candidate 1 for transferring data from calculation resources 20-1 to calculation resources 20-3 passes through calculation resources link 50-1, inter-node link 30-1, inter-node link 30-2 and calculation resources link 50-3. Path candidate 2 for transferring data from calculation resources 20-1 to calculation resources 20-3 passes through calculation resources link 50-1, inter-node link 30-8, inter-node link 30-7, inter-node link 30-6, inter-node link 30-10 and calculation resources link 50-3.

Path candidate storage unit 62 may store the table which is described by nodes passing through a path, like table 621 of nodes on communication path candidates, which is illustrated in FIG. 4. Path candidate storage unit 62 may store the table which is described by links passing through a path, like table 622 of links on communication path candidates, which is illustrated in FIG. 5, or may store both tables in a combined form. For example, when only one inter-node link 30 exists between nodes 10, or when there is no need to distinguish inter-node links, the path candidate storage unit 62 may store only table 621 of nodes on communication path candidates, which is illustrated in FIG. 4.

The information which path candidate storage unit 62 stores is not limited to the modes described in table 621 of nodes on communication path candidates, which is illustrated in FIG. 4, and in table 622 of links on communication path candidates, which is illustrated in FIG. 5. For example, in table 621 of nodes on communication path candidates, which is illustrated in FIG. 4, the names of nodes through which path candidates pass are described. Alternatively, IP addresses or MAC addresses of nodes 10, or identifiers such as labels for specifying such addresses may be described. Besides, two path candidates are described in table 621 of nodes on communication path candidates and in table 622 of links on communication path candidates. However, table 621 of nodes on communication path candidates and table 622 of links on communication path candidates may store, for example, one or a larger arbitrary number of path candidates.

Flow information storage unit 63 stores information of flows existing on the topology of the network, which the topology information storage unit 61 stores. Flow information storage unit 63 stores, for example, with respect to a flow, information for specifying required communication quality, such as a transmission source, a destination, a required bandwidth, and a delay upper limit value.

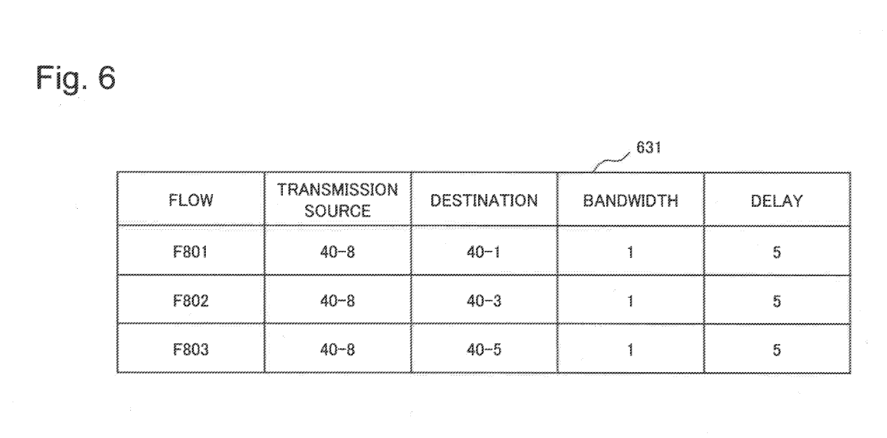

FIG. 6 illustrates a configuration example of flow information table 631 stored in flow information storage unit 63 in the first example embodiment of the present invention. For example, flow F801 is transmitted from virtual machine 40-8 and transferred to virtual machine 40-1. While flow F801 is being transferred from virtual machine 40-8 to virtual machine 40-1, the required bandwidth is 1 and the delay upper limit value is 5 at most.

The information which flow information storage unit 63 stores is not limited to the mode described in flow information table 631 of FIG. 6. For example, in flow information table 631 of FIG. 6, the names of virtual machines 40 are described. However, use may be made of packet information used in specifying communication flows, such as the IP addresses and MAC addresses of virtual machines 40, or port numbers, or a combination thereof. Alternatively, identifiers, such as names or labels, which refer to information for specifying communication flows, may be described in flow information table 631 of FIG. 6. When the information for specifying the communication flow is referred to, the information for specifying the communication flow is recorded on a table or map which is different from flow information table 631 of FIG. 6, in such a form that the information can be referred to by using the identifier as a key.

The information, which flow information storage unit 63 stores, may include a bidirectional link or a unidirectional link. When the information, which flow information storage unit 63 stores, includes a unidirectional link, the information stored in path candidate storage unit 62 is applicable to only the forward direction of the unidirectional link. Similarly, when the bidirectional link is expressed by a pair of unidirectional links in opposite directions, the information stored in flow information storage unit 63 is applicable to only the forward direction of the unidirectional link. In the information which flow information storage unit 63 stores, when the bidirectional link is expressed by a pair of unidirectional links in opposite directions, the identifiers of links are given such that each unidirectional link can be distinguished.

Note that the information of the communication network, which is stored in topology information storage unit 61, path candidate storage unit 62 and flow information storage unit 63, is automatically or manually input from, for example, a network management system (NMS), an operation support system (OSS), or an external data file.

Update procedure calculating unit 64 calculates an update procedure of virtual machine 40 by referring to the information stored in topology information storage unit 61, path candidate storage unit 62 and flow information storage unit 63.

For example, with respect to each virtual machine 40 that is a target of update work, update procedure calculating unit 64 examines, as a move destination candidate, calculation resources 20 which satisfy a communication requirement of a flow which flows into virtual machine 40 that is the target of update work.

For example, referring to flow information storage unit 63, update procedure calculating unit 64 confirms the presence/absence of a flow which flows into each virtual machine 40 that is an update target. When the flow which flows into virtual machine 40 of the update target is present, update procedure calculating unit 64 refers to path candidate storage unit 62 and extracts, as a move destination candidate, a destination which has the same transmission source as the flow and is different from virtual machine 40 of the update target. Note that update procedure calculating unit 64 may refer to not only path candidate storage unit 62 but also flow information storage unit 63, and may extract, as a move destination candidate, a destination which has the same transmission source as the flow and is different from virtual machine 40 of the update target.

Update procedure calculating unit 64 refers to, for example, path candidate storage unit 62 and flow information storage unit 63, extracts paths which satisfy the communication requirement, from among paths from the transmission source of the flow that flows into virtual machine 40 of the update target to a move destination candidate, and determines the extracted paths as set C. For example, update procedure calculating unit 64 compares a delay upper limit value of the flow that flows into virtual machine 40 of the update target and delays of the path candidates extracted from path candidate storage unit 62, extracts paths, which do not exceed the delay upper limit value, as path candidates, and determines the extracted path candidates as set C.

When update procedure calculating unit 64 updates virtual machine 40 by, for example, Blue-Green Deployment or a similar means thereof, synchronization of data and states is needed between a Green slice and a Blue slice. Thus, update procedure calculating unit 64 extracts path candidates with communication requirements which enable synchronization, and determines the extracted path candidates as set C.

Update procedure calculating unit 64 calculates, for example, such a path as to pass through all calculation resources in which virtual machines 40 of update targets exist, with calculation resources 20 (free calculation resources), in which virtual machine 40 is not activated, being set as a start point. For example, using a depth-first search method, update procedure calculating unit 64 calculates such a path as to pass through all calculation resources in which virtual machines 40 of the update work targets exist, with the free resources being set as the start point. It should be noted, however, that the method of calculating such a path as to pass through all calculation resources, in which virtual machines 40 of the update targets exist, is not limited to the depth-first search method, and other calculation methods may be used.

Note that when free calculation resources exist at a plurality of locations, update procedure calculating unit 64 may provide, for example, one dummy node which serves as the start point of path calculation, may connect the dummy node to each node of free calculation resources by a dummy link, and may execute the above-described path calculation by using the dummy node as the start point. For example, after the path calculation, update procedure calculating unit 64 deletes parts of the dummy node and dummy link from the paths. Thereby, update procedure calculating unit 64 can calculate a plurality of paths passing through virtual machines 40 of the update targets, with each free calculation resources being set as the start point.

Update procedure calculating unit 64 transfers a path, which is reverse to the calculated path, to update executing unit 65 as an update procedure of the virtual machines.

Update executing unit 65 executes an update of virtual machines, based on the update procedure of virtual machines, which update procedure calculating unit 64 calculated.

Update executing unit 65, for example, generates a Blue slice of virtual machine 40 of the update target in the free calculation resources. Update executing unit 65 synchronizes states and data of the generated Blue slice and virtual machine 40 of the update target.

After completing the synchronization between the Blue slice and virtual machine 40 of the update target, update executing unit 65 switches the destination of the flow, which flowed into virtual machine 40 of the update target, to the generated Blue slice. Update executing unit 65 selects, from among set C, the path from the transmission source of the flow to the Blue slice. As regards the path from the transmission source of the flow to the Blue slice, update executing unit 65 may select, for example, a shortest path or may select a path with the lowest cost. For example, as the path from the transmission source of the flow to the Blue slice, update executing unit 65 may select a plurality of paths, and may accommodate the flow by multi-path routing.

Note that, before switching the destination of the flow that flowed into virtual machine 40 of the update target to the generated Blue slice, update executing unit 65 controls the network such that the communication of the flow is enabled by the path of the selected path candidate. The execution of the control of the network is not limited to the execution by update executing unit 65 of operation device 60. The control of the network may be executed by, for example, an NMS or OpenFlow controller in a centralized manner. Operation device 60 may be, for example, the NMS or OpenFlow controller. Besides, the control of the network may be executed in a distributed manner by using resource reservation protocol (RSVP).

After switching the destination of the flow that flowed into virtual machine 40 of the update target to the generated Blue slice, update executing unit 65 confirms that the Blue slice is normally operating. After confirming that the Blue slice is normally operating, update executing unit 65 deletes virtual machine 40 which was the update target.

Update executing unit 65 executes an update of virtual machine 40 which is a new update target, by using calculation resources 20 which have newly become free calculation resources. For example, when executing the update of virtual machine 40 of the new update target, update executing unit 65 may set, as the path of the flow to be newly set, the same path as the path of the flow which was used by previously existing virtual machine 40. For example, when update executing unit 65 is unable to re-set the path of the flow which was used by previously existing virtual machine 40, update executing unit 65 deletes the information of this path and sets a new path.

In the above, in the first example embodiment of the present invention, it was assumed that the transmission source of the flow is single virtual machine 40. Alternatively, the transmission source of each flow may be different virtual machines 40. Furthermore, the transmission source of the flow in the present description may be not virtual machine 40 but external network 70.

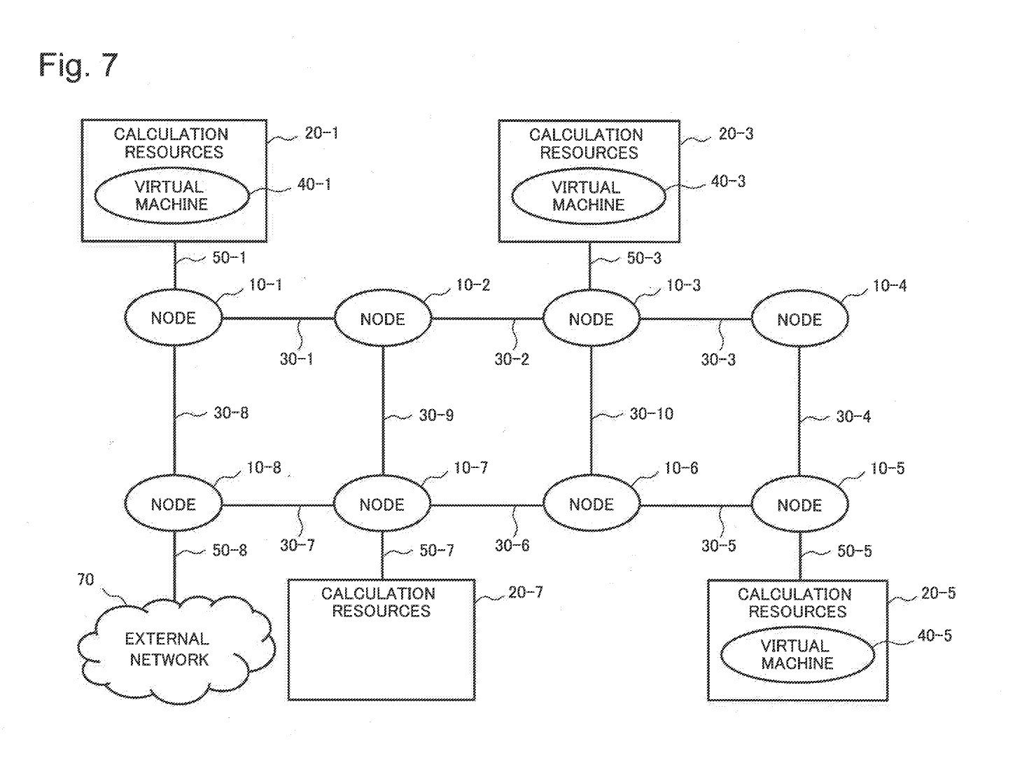

FIG. 7 illustrates a different communication network configuration example in the first example embodiment of the present invention. In the communication network of FIG. 7, node 10-8 is connected to external network 70 via calculation resources link 50-8. External network 70 is, for instance, a physical switch or router, or a virtual switch or router.

When the transmission source is external network 70, the destination of the flow is switched with respect to node 10-8 into which the flow flows from external network 70.

[Description of Operation]

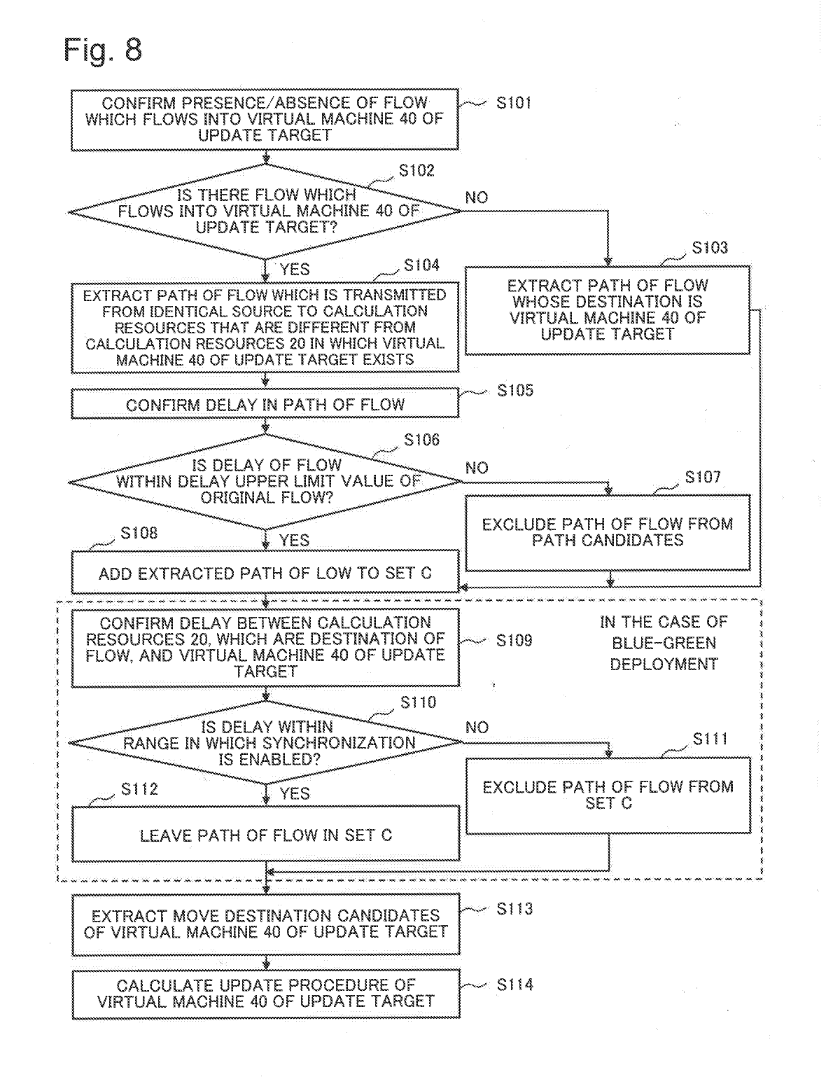

An operation of operation device 60 in the first example embodiment of the present invention will be described with reference to FIG. 8. In the description below, for the purpose of simplicity, the case is described in which virtual machines 40-1, 40-3 and 40-5 are updated in the configuration of the communication network illustrated in FIG. 1.

FIG. 8 is a flowchart illustrating an operation example of update procedure calculating unit 64 in the first example embodiment of the present invention.

Update procedure calculating unit 64 confirms the presence/absence of a flow which flows into virtual machine 40-1 (S101). Referring to the flow information which flow information storage unit 63 stores, update procedure calculating unit 64 confirms that flow F801 is flowing from calculation resources 20-8 into virtual machine 40-1.

When there is no flow which flows into virtual machine 40 of the update target (No in S102), update procedure calculating unit 64 adds to set C a path of a flow whose destination is virtual machine 40 of the update target, by referring to path candidate storage unit 62 (S103). Virtual machine 40-1 does not apply to this case (No in S102).

When there is a flow which flows into virtual machine 40-1 (Yes in S102), update procedure calculating unit 64 extracts, by referring to path candidate storage unit 62, a path of a flow whose transmission source is calculation resources 20-8 and whose destination is not virtual machine 40-1 (S 104).

For example, referring to table 621 of nodes on communication path candidates, update procedure calculating unit 64 extracts six paths as paths of flows whose transmission sources are calculation resources 20-8 and whose destinations are not virtual machine 40-1. The paths which update procedure calculating unit 64 extracted are the following six: [10-8, 10-1, 10-2, 10-3], [10-8, 10-7, 10-6, 10-3], [10-8, 10-1, 10-2, 10-3, 10-6, 10-5], [10-8, 10-7, 10-6, 10-5], [10-8, 10-7], and [10-8, 10-1, 10-2, 10-7]. Note that, referring to table 622 of links on communication path candidates, update procedure calculating unit 64 may extract paths of flows whose transmission sources are calculation resources 20-8 and whose destinations are not virtual machine 40-1.

Update procedure calculating unit 64 confirms delays of the extracted paths of flows (S105).

When the delay of the extracted path of the flow is greater than the delay upper limit value of the flow which originally flowed into the virtual machine 40 of the update target (No in S106), update procedure calculating unit 64 excludes the path of the flow from the path candidates (S 107). When the delay of the extracted path of the flow is not greater than the delay upper limit value of the flow which originally flowed into the virtual machine 40 of the update target (Yes in S106), update procedure calculating unit 64 adds the path of the flow to set C as a path candidate (S 108).

For example, update procedure calculating unit 64 extracts, from the six extracted paths, paths of flows, whose delays are not greater than the delay upper limit value of flow F801 which was flowing into virtual machine 40-1 from calculation resources 20-8. Since the delay upper limit value of flow F801 is 5, update procedure calculating unit 64 extracts five paths, excluding [10-8, 10-1, 10-2, 10-3, 10-6, 10-5] whose delay is 7. Thereby, update procedure calculating unit 64 extracts calculation resources 20-3, 20-5 and 20-7 as move destination candidates of virtual machine 40-1.

For example, in the case of Blue-Green Deployment, update procedure calculating unit 64 compares a specific communication requirement for completing synchronization with the paths of set C (S109). For example, in the first example embodiment of the present invention, it is assumed that in the update of any virtual machine 40, synchronization of virtual machines 40 is possible if a delay between virtual machines 40 is 4 or less. When the delay of a path, among the five extracted path candidates, from virtual machine 40-1 is not 4 or less (No in S110), update procedure calculating unit 64 excludes this path of the flow from set C (S111). When the delay of a path, among the five extracted path candidates, from virtual machine 40-1 is 4 or less (Yes in S110), update procedure calculating unit 64 leaves this path in set C as the path candidate (S112).

By the procedure of S101 to S112, update procedure calculating unit 64 extracts calculation resources 20-3 and 20-7 as move destination candidates of virtual machine 40-1 (S113).

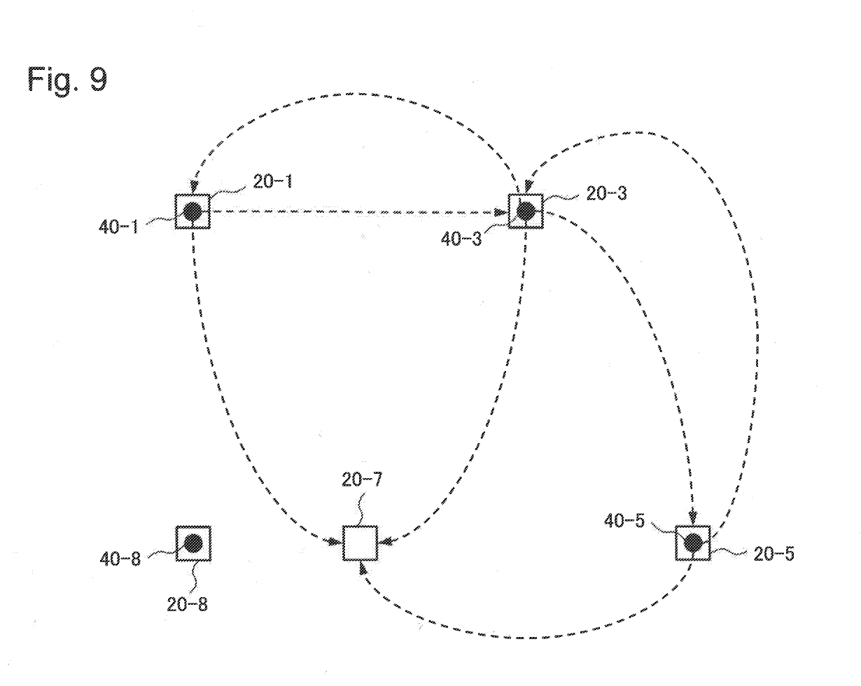

Update procedure calculating unit 64 repeats the procedure of S101 to S112, and extracts move destination candidates of all virtual machines 40 of update targets. FIG. 9 is a view illustrating move destination candidates of virtual machines 40 in the first example embodiment of the present invention. For example, move destination candidates of virtual machine 40-3 are calculation resources 20-1, 20-5 and 20-7. Move destination candidates of virtual machine 40-5 are calculation resources 20-3 and 20-7.

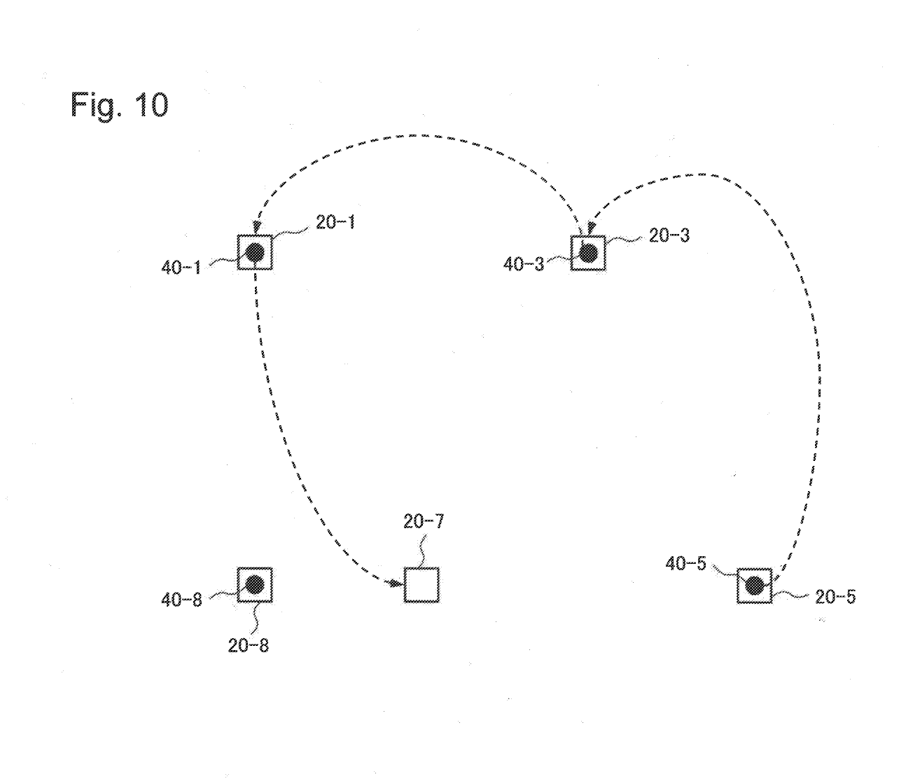

For example, by using a depth-first search method, update procedure calculating unit 64 calculates such a path as to pass through all calculation resources 20 in which virtual machines 40-1, 40-3 and 40-5 of the update work targets exist, with calculation resources 20-7 that are free calculation resources being set as the start point. Update procedure calculating unit 64 calculates, as an update procedure, a path which is reverse to the calculated path (S114). FIG. 10 is a view illustrating an update procedure of virtual machines 40 in the first example embodiment of the present invention. For example, in FIG. 10, virtual machines 40 are updated in the order of virtual machines 40-1, 40-3 and 40-5.

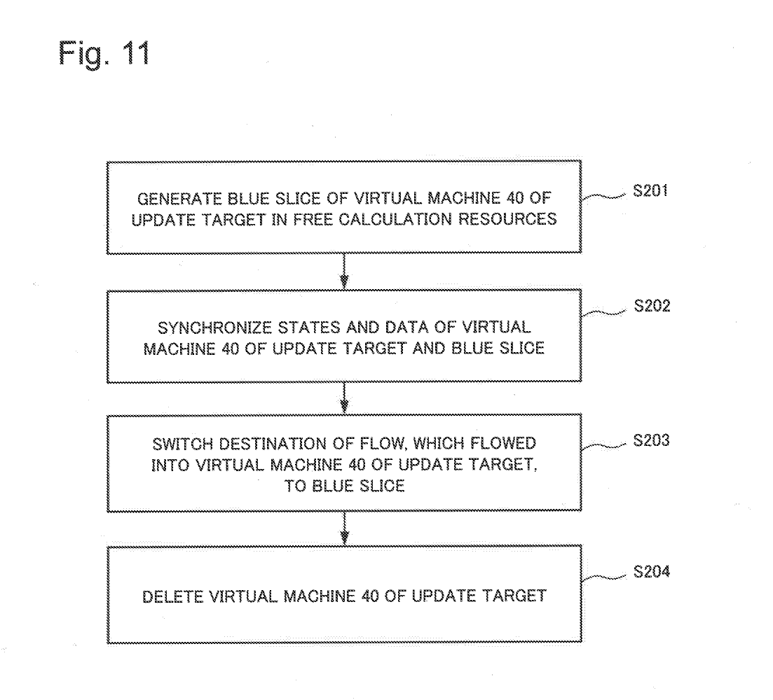

FIG. 11 is a flowchart illustrating an operation example of update executing unit 65 in the first example embodiment of the present invention.

Update executing unit 65 generates a Blue slice of virtual machine 40-1 in calculation resources 20-7 which are free calculation resources (S201).

Update executing unit 65 synchronizes the states and data of the generated Blue slice of virtual machine 40-1 and virtual machine 40-1 (S202).

After completing the synchronization of the states and data of the generated Blue slice of virtual machine 40-1 and virtual machine 40-1, update executing unit 65 switches the destination of flow F801, which is flowing into virtual machine 40-1, to the generated Blue slice (S203).

After confirming that the generated Blue slice is normally operating as virtual machine 40-1, update executing unit 65 deletes virtual machine 40-1 existing in calculation resources 20-1 (S204).

Update executing unit 65 executes an update of virtual machine 40-3 by using calculation resources 20-1 which have newly become free resources. Update executing unit 65 repeats the procedure of S201 to S204, thereby updating all virtual machines 40 which are update targets.

As described above, in the first example embodiment of the present invention, the Blue slice is generated in the free calculation resources, and the operation of switching the destination of the flow, which is flowing into virtual machine 40, is repeated. Thereby, the update of virtual machine 40 can be executed while the state of continuation of communication and services is maintained.

In addition, in the first example embodiment of the present invention, a new Blue slice is generated in calculation resources 20 which have newly become free calculation resources, and the operation of switching the destination of the flow, which flows into virtual machine 40, is repeated. Thereby, it is not necessary to provide the same number of calculation resources 20 as virtual machines 40 of update targets, and surplus resources can be suppressed.

In the above, in the first example embodiment of the present invention, the case in which one flow flows into virtual machines 40 of update targets was described by way of example. The present invention, however, is also applicable in a condition in which a plurality of flows are flowing into virtual machines 40. When plural flows are flowing into virtual machines 40 of update targets, use is made of path candidates and move destination candidates which satisfy requirements with respect to all flows which are flowing in.

### Second Example Embodiment

[Description of Configuration]

A second example embodiment of the present invention will be described with reference to the drawings. Note that the technique of the second example embodiment is applicable to each of the first example embodiment and example embodiments to be described later.

Since a configuration example of the communication system of the second example embodiment is similar to the configuration example of the communication system of the first example embodiment illustrated in FIG. 1, a detailed description thereof is omitted.

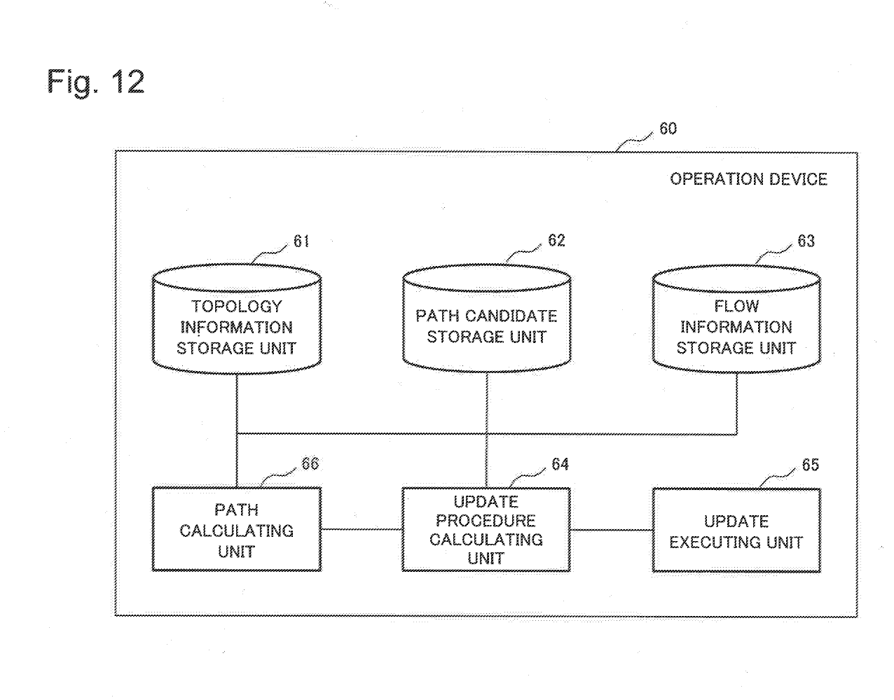

FIG. 12 illustrates a configuration example of operation device 60 in the second example embodiment of the present invention.

Operation device 60 in the second example embodiment of the present invention manages the communication network in the first example embodiment of the present invention. Operation device 60 includes topology information storage unit 61, path candidate storage unit 62, flow information storage unit 63, update procedure calculating unit 64, update executing unit 65, and path calculating unit 66.

Note that solid lines connecting structural elements 61 to 66 in FIG. 12 indicate logical communication or a callable relationship, and an implementation of structural elements 61 to 66 of the present invention is not limited to the configuration or network in which structural elements 61 to 66 are connected in the illustrated shape.

Path candidate storage unit 62 stores candidate information of communication paths between calculation resources 20, the communication paths existing on the topology of the communication network stored in topology information storage unit 61. Path candidate storage unit 62 stores one or a plurality of candidates for communication paths between calculation resources 20 in which virtual machines 40 can be disposed, in the topology stored in topology information storage unit 61. Since configuration examples of candidate information of communication paths, which is stored in path candidate storage unit 62, are similar to the configuration examples of the candidate information of communication paths, which is stored in path candidate storage unit 62 in the first example embodiment illustrated in FIG. 4 and FIG. 5, a detailed description thereof is omitted.

The information which path candidate storage unit 62 stores may be saved by a user or may be saved by path calculating unit 66.

Path candidate storage unit 62 may not be included in operation device 60, for example, in the case in which update procedure calculating unit 64 asks path calculating unit 66 each time about candidate information of communication paths existing on the topology of the communication network.

Update procedure calculating unit 64 calculates an update procedure of virtual machines by referring to the information stored in topology information storage unit 61, path candidate storage unit 62 and flow information storage unit 63. For example, with respect to each virtual machine 40 which is an update work target, update procedure calculating unit 64 examines, as a move destination candidate, calculation resources 20 which satisfy, as a move destination, a communication requirement of a flow that flows in.

Update procedure calculating unit 64 instructs, for example, path calculating unit 66 to calculate a path between calculation resources 20 in the communication network. For example, when path candidates are already stored in path candidate storage unit 62, update procedure calculating unit 64 may not instruct the calculation of the path between calculation resources 20 in the communication network, or may instruct an update of the path between calculation resources 20 in the communication network.

Referring to flow information storage unit 63, update procedure calculating unit 64 confirms the presence/absence of a flow which flows into each virtual machine 40 that is an update target.

Update procedure calculating unit 64 refers to the calculated information stored in path candidate storage unit 62, and extracts, as a move destination candidate, a destination which has the same transmission source as the flow and is different from virtual machine 40 of the update target.

Note that update procedure calculating unit 64 may refer to not only path candidate storage unit 62 but also flow information storage unit 63, and may extract, as a move destination candidate, a destination which has the same transmission source as the flow and is different from virtual machine 40 of the update target.

For example, in the case in which update procedure calculating unit 64 asks path calculating unit 66 each time about candidate information of paths between calculation resources 20 in the communication network, update procedure calculating unit 64 may acquire the candidate information of communication paths from path calculating unit 66.

Since the process in which update procedure calculating unit 64 calculates the update procedure is similar to the process in the example of update procedure calculating unit 64 in the first example embodiment, a detailed description thereof is omitted.

Update procedure calculating unit 64 transfers the calculated update procedure of virtual machines 40 to update executing unit 65.

Path calculating unit 66 calculates a path for a flow, in response to a path calculation request from the outside.

Path calculating unit 66 acquires the topology information of the communication network from topology information storage unit 61. From the acquired topology information of the communication network, path calculating unit 66 calculates a path between calculation resources 20 in the communication network. Path calculating unit 66 calculates the path by using, for example, a heuristic method such as constrained shortest path first (CSPF) or genetic algorithm (GA).

Path calculating unit 66 stores the calculated path information, for example, in path candidate storage unit 62.

Since the other configuration of operation device 60 is similar to the configuration example of operation device 60 in the first example embodiment illustrated in FIG. 2, a detailed description thereof is omitted.

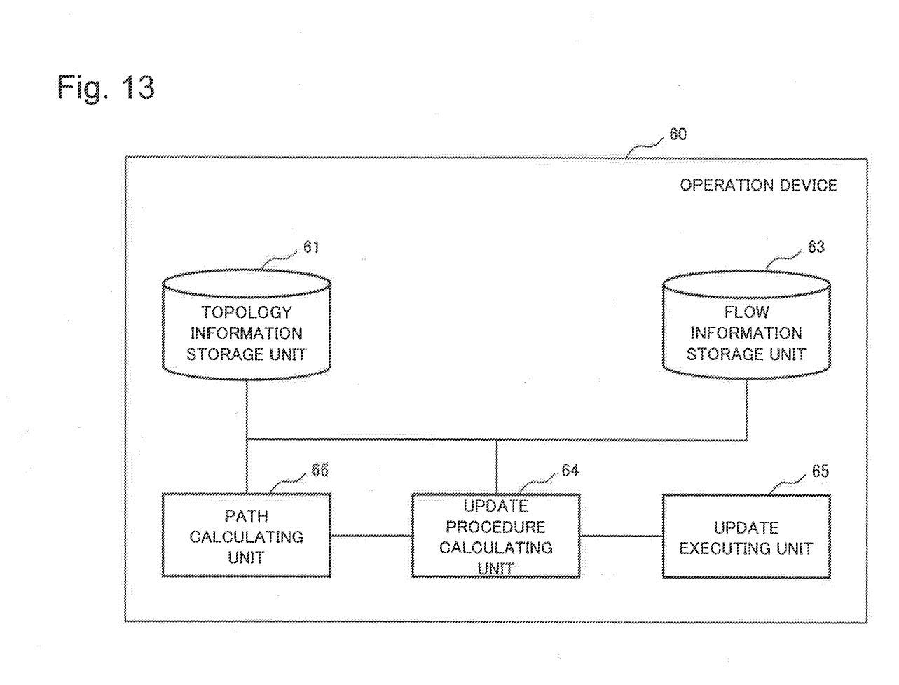

FIG. 13 is a view illustrating a different configuration example of operation device 60 in the second example embodiment of the present invention. For example, when path candidate storage unit 62 is not included in operation device 60, path calculating unit 66 may transfer the calculated path to update procedure calculating unit 64.

[Description of Operation]

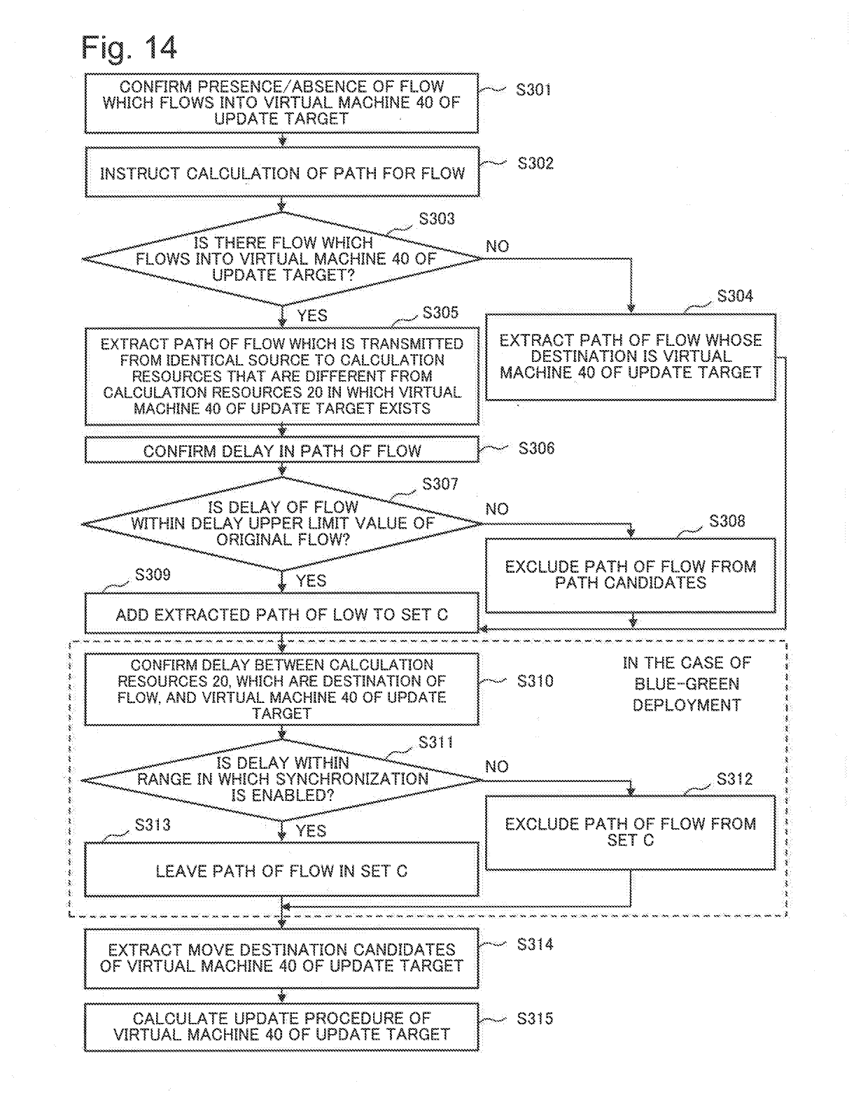

An operation of operation device 60 in the second example embodiment of the present invention will be described with reference to FIG. 14. In the description below, for the purpose of simplicity, a case is described in which virtual machines 40-1, 40-3 and 40-5 are update in the configuration of the communication network illustrated in FIG. 1.

FIG. 14 is a flowchart illustrating an operation example of update procedure calculating unit 64 in the second example embodiment of the present invention.

Update procedure calculating unit 64 confirms the presence/absence of a flow which flows into virtual machine 40-1 (S301). Referring to the flow information which flow information storage unit 63 stores, update procedure calculating unit 64 confirms that flow F801 is flowing from calculation resources 20-8 into virtual machine 40-1.

Update procedure calculating unit 64 instructs path calculating unit 66 to calculate the path between calculation resources 20 in the communication network (S302). Path calculating unit 66 refers to topology information storage unit 61, and calculates the path between calculation resources 20 in the communication network. Path calculating unit 66 stores the calculated path in path candidate storage unit 62.

When there is no flow which flows into virtual machine 40 of the update target (No in S303), update procedure calculating unit 64 adds to set C a path of a flow whose destination is virtual machine 40 of the update target, by referring to path candidate storage unit 62 (S304). Virtual machine 40-1 does not apply to this case (No in S303).

When there is a flow which flows into virtual machine 40-1 (Yes in S303), update procedure calculating unit 64 extracts, by referring to path candidate storage unit 62, a path of a flow whose transmission source is calculation resources 20-8 and whose destination is not virtual machine 40-1 (S305).

Since subsequent S306 to S315 are similar to S105 to S114 in the operation example of update procedure calculating unit 64 of the first example embodiment illustrated in FIG. 8, a detailed description thereof is omitted.

As described above, in the second example embodiment of the present invention, the Blue slice is generated in the free calculation resources, and the operation of switching the destination of the flow, which is flowing into virtual machine 40, is repeated. Thereby, the update of virtual machine 40 can be executed while the state of continuation of communication and services is maintained.

In addition, in the second example embodiment of the present invention, a new Blue slice is generated in calculation resources 20 which have newly become free calculation resources, and the operation of switching the destination of the flow, which flows into virtual machine 40, is repeated. Thereby, it is not necessary to provide the same number of calculation resources 20 as virtual machines 40 of update targets, and surplus resources can be suppressed.

In the second example embodiment of the present invention, operation device 60 itself refers to the topology information and flow information of the network, thereby calculating path candidates for the flow. Thereby, it is not necessary for the user to set path candidates in advance, and the update work of virtual machines 40 can be simplified.

In the above, in the second example embodiment of the present invention, the case in which one flow flows into virtual machines 40 of update targets was described by way of example. The present invention, however, is also applicable in a condition in which a plurality of flows are flowing into virtual machines 40. When plural flows are flowing into virtual machines 40 of update targets, use is made of path candidates and move destination candidates which satisfy requirements with respect to all flows which are flowing in.

### Third Example Embodiment

[Description of Configuration]

A third example embodiment of the present invention will be described with reference to the drawings. Note that the technique of the third example embodiment is applicable to each of the first example embodiment, second example embodiment, and example embodiments to be described later.

Since a configuration example of the communication system of the third example embodiment is similar to the configuration example of the communication system of the first example embodiment illustrated in FIG. 1, a detailed description thereof is omitted.

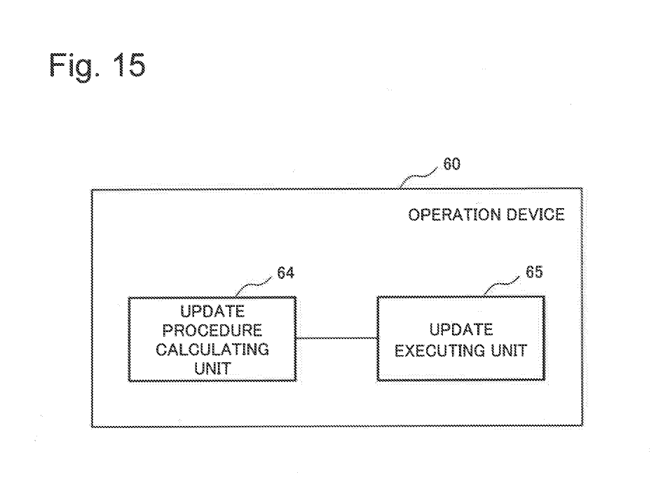

FIG. 15 illustrates a configuration example of operation device 60 in the third example embodiment of the present invention.

Operation device 60 in the third example embodiment of the present invention manages the communication network in the first example embodiment of the present invention. Operation device 60 includes update procedure calculating unit 64 and update executing unit 65.

Note that a solid line connecting structural elements 64 and 65 in FIG. 15 indicates logical communication or a callable relationship, and an implementation of structural elements 64 and 65 of the present invention is not limited to the configuration or network in which structural elements 64 and 65 are connected in the illustrated shape.

Update procedure calculating unit 64 calculates an update procedure of virtual machines 40.

For example, with respect to each virtual machine 40 which is a target of update work, update procedure calculating unit 64 examines, as move destination candidate, calculation resources 20 which satisfy a communication requirement of a flow that flows into the virtual machine 40 which is the target of update work.

For example, update procedure calculating unit 64 confirms the presence/absence of a flow which flows into each virtual machine 40 that is an update target. When there is a flow which flows into the virtual machine 40 of the update target, update procedure calculating unit 64 extracts, as a move destination candidate, a destination which has the same transmission source as the flow and is different from virtual machine 40 of the update target.

Update procedure calculating unit 64 extracts, for example, paths which satisfy a communication requirement, from among paths from the transmission source of the flow that flows into virtual machine 40 of the update target to a move destination candidate, and determines the extracted paths as set C. For example, update procedure calculating unit 64 compares a delay upper limit value of the flow that flows into virtual machine 40 of the update target with delays of the extracted path candidates, extracts paths, which do not exceed the delay upper limit value, as path candidates, and determines the extracted path candidates as set C.

When update procedure calculating unit 64 updates virtual machine 40 by, for example, Blue-Green Deployment or a similar means thereof, synchronization of data and states is needed between a Green slice and a Blue slice. Thus, update procedure calculating unit 64 extracts path candidates with communication requirements which enable synchronization, and determines the extracted path candidates as set C.

Update procedure calculating unit 64 calculates, for example, such a path as to pass through all calculation resources in which virtual machines 40 of the update targets exist, with calculation resources 20 (free calculation resources), in which virtual machine 40 is not activated, being set as a start point. For example, using a depth-first search method, update procedure calculating unit 64 calculates such a path as to pass through all calculation resources in which virtual machines 40 of the update work targets exist, with the free resources being set as the start point. It should be noted, however, that the method of calculating such a path as to pass through all calculation resources, in which virtual machines 40 of the update targets exist, is not limited to the depth-first search method, and other calculation methods may be used.

Note that when free calculation resources exist at a plurality of locations, update procedure calculating unit 64 may provide, for example, one dummy node which serves as the start point of path calculation, may connect the dummy node to each node of free calculation resources by a dummy link, and may execute the path calculation by using the dummy node as the start point. For example, after the path calculation, update procedure calculating unit 64 deletes parts of the dummy node and dummy link from the paths. Thereby, update procedure calculating unit 64 can calculate a plurality of paths passing through virtual machines 40 of the update targets, with each free calculation resources being set as the start point.

Update procedure calculating unit 64 transfers a path, which is reverse to the calculated path, to update executing unit 65 as an update procedure of the virtual machines.

Update executing unit 65 executes an update of virtual machines, based on the update procedure of virtual machines, which update procedure calculating unit 64 calculated.

Update executing unit 65, for example, generates a Blue slice of virtual machine 40 of the update target in the free calculation resources. Update executing unit 65 synchronizes states and data of the generated Blue slice and virtual machine 40 of the update target.

After completing the synchronization between the Blue slice and virtual machine 40 of the update target, update executing unit 65 switches the destination of the flow, which flowed into virtual machine 40 of the update target, to the generated Blue slice. Update executing unit 65 selects, from among set C, the path from the transmission source of the flow to the Blue slice. As regards the path from the transmission source of the flow to the Blue slice, update executing unit 65 may select, for example, a shortest path or may select a path with the lowest cost. For example, as the path from the transmission source of the flow to the Blue slice, update executing unit 65 may select a plurality of paths, and may accommodate the flow by multi-path routing.

Note that, before switching the destination of the flow that flowed into virtual machine 40 of the update target to the generated Blue slice, update executing unit 65 controls the network such that the communication of the flow is enabled by the path of the selected path candidate. The execution of the control of the network is not limited to the execution by update executing unit 65 of operation device 60. The control of the network may be executed by, for example, an NMS or OpenFlow controller in a centralized manner. Operation device 60 may be, for example, the NMS or OpenFlow controller. Besides, the control of the network may be executed in a distributed manner by using RSVP.

After switching the destination of the flow that flowed into virtual machine 40 of the update target to the generated Blue slice, update executing unit 65 confirms that the Blue slice is normally operating. After confirming that the Blue slice is normally operating, update executing unit 65 deletes virtual machine 40 which was the update target.

Update executing unit 65 executes an update of virtual machine 40 which is a new update target, by using calculation resources 20 which have newly become free calculation resources. For example, when executing the update of virtual machine 40 of the new update target, update executing unit 65 may set, as the path of the flow to be newly set, the same path as the path of the flow which was used by previously existing virtual machine 40. For example, when update executing unit 65 is unable to re-set the path of the flow which was used by the previously existing virtual machine 40, update executing unit 65 deletes the information of this path and sets a new path.

In the above, in the third example embodiment of the present invention, it was assumed that the transmission source of the flow is single virtual machine 40. Alternatively, the transmission source of each flow may be different virtual machines 40. Furthermore, the transmission source of the flow in the present description may be not virtual machine 40 but external network 70. Since a configuration example in a case in which the transmission source of the flow is external network 70 is similar to the configuration example of the first example embodiment illustrated in FIG. 7, a detailed description thereof is omitted.

[Description of Operation]

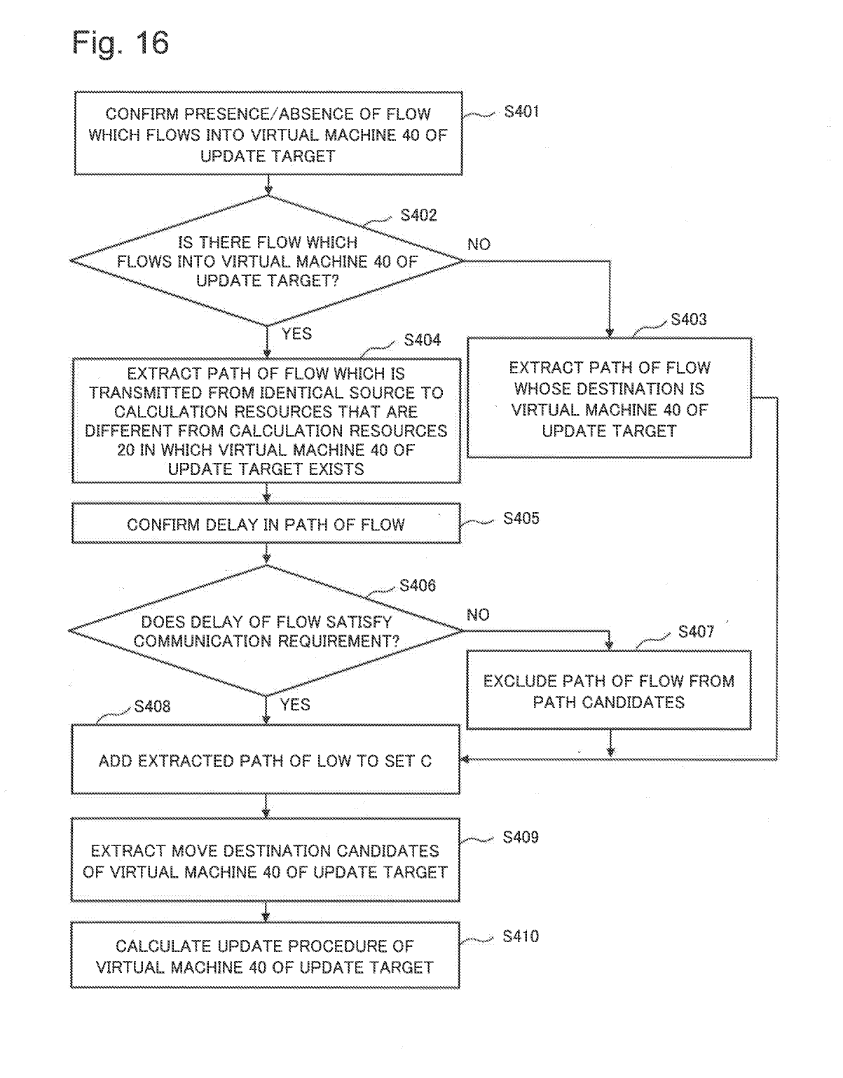

An operation of operation device 60 in the third example embodiment of the present invention will be described with reference to FIG. 16. In the description below, for the purpose of simplicity, the case is described in which virtual machines 40-1, 40-3 and 40-5 are updated in the configuration of the communication network illustrated in FIG. 1.

FIG. 16 is a flowchart illustrating an operation example of update procedure calculating unit 64 in the third example embodiment of the present invention.

Update procedure calculating unit 64 confirms the presence/absence of a flow which flows into virtual machine 40-1 (S401). Update procedure calculating unit 64 confirms that flow F801 is flowing from calculation resources 20-8 into virtual machine 40-1.

When there is no flow which flows into virtual machine 40 of the update target (No in S402), update procedure calculating unit 64 adds to set C a path of a flow whose destination is virtual machine 40 of the update target (S403). Virtual machine 40-1 does not apply to this case (No in S402).

When there is a flow which flows into virtual machine 40-1 (Yes in S402), update procedure calculating unit 64 extracts a path of a flow whose transmission source is calculation resources 20-8 and whose destination is not virtual machine 40-1 (S404).

Update procedure calculating unit 64 confirms delays of the extracted paths of flows (S405).

When the delay of the extracted path of the flow fails to satisfy the communication requirement (No in S406), update procedure calculating unit 64 excludes the path of the flow from the path candidates (S407). When the delay of the extracted path of the flow satisfies the communication requirement (Yes in S406), update procedure calculating unit 64 adds the path of the flow to set C as a path candidate (S408).

Update procedure calculating unit 64 repeats the procedure of S401 to S408, and extracts move destination candidates of all virtual machines 40 of update targets (S409).

For example, by using a depth-first search method, update procedure calculating unit 64 calculates such a path as to pass through all calculation resources 20 in which virtual machines 40-1, 40-3 and 40-5 of the update work targets exist, with free calculation resources being set as the start point. Update procedure calculating unit 64 calculates, as an update procedure, a path which is reverse to the calculated path (S410).

Since an operation example of update executing unit 65 of the third example embodiment is similar to the operation example of update executing unit 65 of the first example embodiment illustrated in FIG. 11, a detailed description thereof is omitted.

As described above, in the third example embodiment of the present invention, the Blue slice is generated in the free calculation resources, and the operation of switching the destination of the flow, which flows into virtual machine 40, is repeated. Thereby, the update of virtual machine 40 can be executed while the state of continuation of communication and services is maintained.

In addition, in the third example embodiment of the present invention, a new Blue slice is generated in calculation resources 20 which have newly become free calculation resources, and the operation of switching the destination of the flow, which flows into virtual machine 40, is repeated. Thereby, it is not necessary to provide the same number of calculation resources 20 as virtual machines 40 of update targets, and surplus resources can be suppressed.

In the above, in the third example embodiment of the present invention, the case in which one flow flows into virtual machines 40 of update targets was described by way of example. The present invention, however, is also applicable in a condition in which a plurality of flows are flowing into virtual machines 40. When plural flows flow into virtual machines 40 of update targets, use is made of path candidates and move destination candidates which satisfy requirements with respect to all flows which are flowing in.

The example embodiments of the present invention have been described above. The present invention, however, is not limited to each of the above-described example embodiments. The present invention can be implemented based on modifications, substitutions and adjustments of the respective example embodiments. In addition, the present invention can be implemented by arbitrarily combining the example embodiments. Specifically, the present invention includes various modifications and alterations, which can be realized in accordance with all disclosed contents and technical concepts in the present specification. Furthermore, the present invention is also applicable to the technical field of software-defined network (SDN).

Besides, in the example embodiments of the present invention, the operation device such as a computer, CPU, micro-processing unit (MPU) may execute software (program) which realizes the functions of the above-described example embodiments. The computer, CPU, MPU of the operation device may acquire the software (program) which realizes the functions of the above-described example embodiments, for example, via various storage media such as a compact disc recordable (CD-R), or a network. The program which the operation device acquires, or the storage medium which stores the program, will constitute the present invention. Note that the software (program) may be prestored, for example, in a predetermined storage unit included in the operation device. The computer, CPU, MPU of the operation device may read out and execute program code of the acquired software (program).

Although the present invention was described above by referring to each example embodiment, the present invention is not limited to the above-described example embodiments. Various changes, which are understandable to a skilled person within the scope of the present invention, can be made to the configurations and details of the present invention.

The present application claims priority, based on Japanese Patent Application No. 2016-066980, filed Mar. 30, 2016; the entire contents of which are incorporated herein by reference.

A part or all of the above example embodiments can be described as in Supplementary Note below, but are not limited to the following.

### [Supplementary Note 1]

An operation device comprising:

update procedure calculating means that determines an update procedure for sequentially updating a virtual machine; and

update executing means that executes an update of a plurality of the virtual machines in accordance with the determined update procedure,

wherein the update procedure calculating means is configured:

to extract candidates for calculation resources of an update destination with respect to each of the virtual machines, and

to determine the calculation resources of the update destination of each of the virtual machines and an order of updating the virtual machines, based on the extracted candidates for the calculation resources of the update destination.

### [Supplementary Note 2]

The operation device according to Supplementary Note 1, wherein the update procedure calculating means determines the calculation resources, in which the virtual machine is not activated, as the calculation resources of the update destination of the virtual machine which is to be first updated.

### [Supplementary Note 3]

The operation device according to Supplementary Note 1 or 2, wherein the update procedure calculating means extracts the candidates for the calculation resources of the update destination with respect to each of the virtual machines, based on a flow which flows into each of the virtual machines.

### [Supplementary Note 4]

The operation device according to Supplementary Note 3, wherein the update procedure calculating means extracts, as the candidates for the calculation resources of the update destination, the calculation resources with which the virtual machine of a transmission source of the flow is communicable.

### [Supplementary Note 5]

The operation device according to Supplementary Note 3 or 4, wherein the update procedure calculating means extracts, as the candidates for the calculation resources of the update destination, the calculation resources which satisfy a condition relating to communication of the flow.

### [Supplementary Note 6]

The operation device according to any one of Supplementary Notes 3 to 5, wherein the update procedure calculating means determines, as the calculation resources of the update destination, the calculation resources which are among the extracted candidates for the calculation resources of the update destination and with respect to which a time necessary for the update of the virtual machine does not exceed a delay tolerable time of the flow.

### [Supplementary Note 7]

A communication system comprising:

calculation resources in which a virtual machine is constituted; and

an operation device that instructs an update of the virtual machine,

the operation device comprising:

update procedure calculating means that determines an update procedure for sequentially updating a plurality of the virtual machines; and

update executing means that executes an update of the virtual machines in accordance with the determined update procedure,

wherein the update procedure calculating means is configured:

to extract candidates for calculation resources of an update destination with respect to each of the virtual machines, and

to determine the calculation resources of the update destination of each of the virtual machines and an order of updating the virtual machines, based on the extracted candidates for the calculation resources of the update destination.

### [Supplementary Note 8]

The communication system according to Supplementary Note 7, wherein the update procedure calculating means determines the calculation resources, in which the virtual machine is not activated, as the calculation resources of the update destination of the virtual machine which is to be first updated.

### [Supplementary Note 9]

The communication system according to Supplementary Note 7 or 8, wherein the update procedure calculating means extracts the candidates for the calculation resources of the update destination with respect to each of the virtual machines, based on a flow which flows into each of the virtual machines.

### [Supplementary Note 10]

The communication system according to Supplementary Note 9, wherein the update procedure calculating means extracts, as the candidates for the calculation resources of the update destination, the calculation resources with which the virtual machine of a transmission source of the flow is communicable.

### [Supplementary Note 11]

The communication system according to Supplementary Note 9 or 10, wherein the update procedure calculating means extracts, as the candidates for the calculation resources of the update destination, the calculation resources which satisfy a condition relating to communication of the flow.

### [Supplementary Note 12]

The communication system according to any one of Supplementary Notes 9 to 11, wherein the update procedure calculating means determines, as the calculation resources of the update destination, the calculation resources which are among the extracted candidates for the calculation resources of the update destination and with respect to which a time necessary for the update of the virtual machine does not exceed a delay tolerable time of the flow.

### [Supplementary Note 13]

An update method for sequentially updating a virtual machine, comprising:

extracting candidates for calculation resources of an update destination with respect to each of a plurality of the virtual machines;

determining the calculation resources of the update destination of each of the virtual machines and an order of updating the virtual machines, based on the extracted candidates for the calculation resources of the update destination; and

executing an update of the virtual machines in accordance with the determined order of updating.

### [Supplementary Note 14]

The update method according to Supplementary Note 13, further comprising determining the calculation resources, in which the virtual machine is not activated, as the calculation resources of the update destination of the virtual machine which is to be first updated.

### [Supplementary Note 15]

The update method according to Supplementary Note 13 or 14, further comprising extracting the candidates for the calculation resources of the update destination with respect to each of the virtual machines, based on a flow which flows into each of the virtual machines.

### [Supplementary Note 16]

The update method according to Supplementary Note 15, further comprising extracting, as the candidates for the calculation resources of the update destination, the calculation resources with which the virtual machine of a transmission source of the flow is communicable.

### [Supplementary Note 17]

The update method according to Supplementary Note 15 or 16, further comprising extracting, as the candidates for the calculation resources of the update destination, the calculation resources which satisfy a condition relating to communication of the flow.

### [Supplementary Note 18]

The update method according to any one of Supplementary Notes 15 to 17, further comprising determining, as the calculation resources of the update destination, the calculation resources which are among the extracted candidates for the calculation resources of the update destination and with respect to which a time necessary for the update of the virtual machine does not exceed a delay tolerable time of the flow.

### [Supplementary Note 19]

An update method for sequentially updating a virtual machine, comprising:

extracting candidates for calculation resources of an update destination with respect to each of a plurality of the virtual machines;

determining the calculation resources of the update destination of each of the virtual machines and an order of updating the virtual machines, based on the extracted candidates for the calculation resources of the update destination; and

executing an update of the virtual machines in accordance with the determined order of updating.

### [Supplementary Note 20]

The update method according to Supplementary Note 19, further comprising determining the calculation resources, in which the virtual machine is not activated, as the calculation resources of the update destination of the virtual machine which is to be first updated.

### [Supplementary Note 21]

The update method according to Supplementary Note 19 or 20, further comprising extracting the candidates for the calculation resources of the update destination with respect to each of the virtual machines, based on a flow which flows into each of the virtual machines.

### [Supplementary Note 22]

The update method according to Supplementary Note 21, further comprising extracting, as the candidates for the calculation resources of the update destination, the calculation resources with which the virtual machine of a transmission source of the flow is communicable.

### [Supplementary Note 23]

The update method according to Supplementary Note 21 or 22, further comprising extracting, as the candidates for the calculation resources of the update destination, the calculation resources which satisfy a condition relating to communication of the flow.

### [Supplementary Note 24]

The update method according to any one of Supplementary Notes 21 to 23, further comprising determining, as the calculation resources of the update destination, the calculation resources which are among the extracted candidates for the calculation resources of the update destination and with respect to which a time necessary for the update of the virtual machine does not exceed a delay tolerable time of the flow.

### REFERENCE SIGNS LIST

10 Node
20 Calculation resources
30 Inter-node link
40 Virtual machine
50 Calculation resources link
60 Operation device
61 Topology information storage unit
611 Network topology management table
62 Path candidate storage unit
621 Table of nodes on communication path candidates
622 Table of links on communication path candidates
63 Flow information storage unit
631 Flow information table
64 Update procedure calculating unit
65 Update executing unit
66 Path calculating unit
70 External network

What is claimed is:

1. An operation device comprising:
a memory, and
one or more processors implemented function as:
an update procedure calculating unit configured to determine an update procedure for sequentially updating a virtual machine; and
an update executing unit configured to execute an update of a plurality of the virtual machines in accordance with the determined update procedure,
wherein the update procedure calculating unit is configured:
to extract candidates for calculation resources of an update destination with respect to each of the virtual machines, and
to determine the calculation resources of the update destination of each of the virtual machines and an order of updating the virtual machines, based on the extracted candidates for the calculation resources of the update destination.

2. The operation device according to claim 1, wherein the update procedure calculating unit determines the calculation resources, in which the virtual machine is not activated, as the calculation resources of the update destination of the virtual machine which is to be first updated.

3. The operation device according to claim 1, wherein the update procedure calculating unit extracts the candidates for the calculation resources of the update destination with respect to each of the virtual machines, based on a flow which flows into each of the virtual machines.

4. The operation device according to claim 3, wherein the update procedure calculating unit extracts, as the candidates for the calculation resources of the update destination, the calculation resources with which the virtual machine of a transmission source of the flow is communicable.

5. The operation device according to claim 3, wherein the update procedure calculating unit extracts, as the candidates for the calculation resources of the update destination, the calculation resources which satisfy a condition relating to communication of the flow.

6. The operation device according to claim 3, wherein the update procedure calculating unit determines, as the calculation resources of the update destination, the calculation resources which are among the extracted candidates for the calculation resources of the update destination and with respect to which a time necessary for the update of the virtual machine does not exceed a delay tolerable time of the flow.

7. A communication system comprising:
calculation resources in which a virtual machine is constituted; and
an operation device for instructing an update of the virtual machine,
the operation device comprising:
a memory, and
one or more processors implemented function as:
an update procedure calculating unit configured to determine an update procedure for sequentially updating a plurality of the virtual machines; and
an update executing unit configured to execute an update of the virtual machines in accordance with the determined update procedure,
wherein the update procedure calculating unit is configured:
to extract candidates for calculation resources of an update destination with respect to each of the virtual machines, and
to determine the calculation resources of the update destination of each of the virtual machines and an order of updating the virtual machines, based on the extracted candidates for the calculation resources of the update destination.

8. The communication system according to claim 7, wherein the update procedure calculating unit determines the calculation resources, in which the virtual machine is not activated, as the calculation resources of the update destination of the virtual machine which is to be first updated.

9. The communication system according to claim 7, wherein the update procedure calculating unit extracts the candidates for the calculation resources of the update destination with respect to each of the virtual machines, based on a flow which flows into each of the virtual machines.

10. The communication system according to claim 9, wherein the update procedure calculating unit extracts, as the candidates for the calculation resources of the update destination, the calculation resources with which the virtual machine of a transmission source of the flow is communicable.

11. The communication system according to claim 9, wherein the update procedure calculating unit extracts, as the candidates for the calculation resources of the update destination, the calculation resources which satisfy a condition relating to communication of the flow.

12. The communication system according claim 9, wherein the update procedure calculating unit determines, as the calculation resources of the update destination, the calculation resources which are among the extracted candidates for the calculation resources of the update destination and with respect to which a time necessary for the update of the virtual machine does not exceed a delay tolerable time of the flow.

13. An update method for sequentially updating a virtual machine, comprising:
extracting candidates for calculation resources of an update destination with respect to each of a plurality of the virtual machines;
determining the calculation resources of the update destination of each of the virtual machines and an order of updating the virtual machines, based on the extracted candidates for the calculation resources of the update destination; and
executing an update of the virtual machines in accordance with the determined order of updating.

14. The update method according to claim 13, further comprising determining the calculation resources, in which the virtual machine is not activated, as the calculation resources of the update destination of the virtual machine which is to be first updated.

15. The update method according to claim 13, further comprising extracting the candidates for the calculation resources of the update destination with respect to each of the virtual machines, based on a flow which flows into each of the virtual machines.

16. The update method according to claim 15, further comprising extracting, as the candidates for the calculation resources of the update destination, the calculation resources with which the virtual machine of a transmission source of the flow is communicable.

17. The update method according to claim 15, further comprising extracting, as the candidates for the calculation resources of the update destination, the calculation resources which satisfy a condition relating to communication of the flow.

18. The update method according to claim 15, further comprising determining, as the calculation resources of the update destination, the calculation resources which are among the extracted candidates for the calculation resources of the update destination and with respect to which a time necessary for the update of the virtual machine does not exceed a delay tolerable time of the flow.

19. (canceled)

20. (canceled)

21. (canceled)

22. (canceled)

23. (canceled)

24. (canceled)
